(19) United States
(12) Patent Application Publication
(10) Pub. No.: US 2023/0289195 A1
(43) Pub. Date: Sep. 14, 2023

(54) INFORMATION PROCESSING APPARATUS AND CONTROL METHOD

(71) Applicant: Lenovo (Singapore) Pte. Ltd., Singapore (SG)

(72) Inventor: Kazuhiro Kosugi, Kanagawa (JP)

(73) Assignee: Lenovo (Singapore) Pte. Ltd., Singapore (SG)

(21) Appl. No.: 18/173,062

(22) Filed: Feb. 23, 2023

(30) Foreign Application Priority Data
Mar. 14, 2022 (JP) 2022-039627

(51) Int. Cl. G06F 9/4401; G06V 40/16

(52) U.S. Cl. CPC G06F 9/4418; G06V 40/166

(57) ABSTRACT

An information processing apparatus includes: a memory which temporarily stores a program of an Operating System (OS); a first processor which executes the program to implement functions of the OS; and a second processor which detects a face area with a face captured therein from an image captured by an imaging unit. When the face area is no longer detected from a state where the face area is detected by the second processor, the first processor performs first processing to limit use of at least some of the functions of the OS in response to the fact that a state where the face area is not detected has lasted for a predetermined first time.

### CROSS-REFERENCE TO RELATED APPLICATIONS

This application claims priority to Japanese Patent Application No. 2022-39627 filed on Mar. 14, 2022, the contents of which are hereby incorporated herein by reference in their entirety.

### TECHNICAL FIELD

The present invention relates to an information processing apparatus and a control method.

### BACKGROUND

There is an apparatus which makes a transition to a usable operating state when a person approaches or to a standby state in which functions except some of the functions are stopped when the person leaves. For example, in Japanese Unexamined Patent Application Publication No. 2016-148895, there is disclosed a technique for detecting the intensity of infrared light using an infrared sensor to detect whether a person is approaching or a person has left in order to control the operating state of the apparatus.

In recent years, with the development of computer vision and the like, detection accuracy when detecting a face from an image has been getting higher. Therefore, face detection is beginning to be used instead of person detection using the infrared sensor. Infrared light is reflected back regardless of whether it is a person or an object other than the person when using the infrared sensor, but the use of face detection can suppress just an object from being detected as a person by mistake. For example, an apparatus such as a personal computer is equipped with a camera to capture an image for face detection described above in a position capable of capturing an image of the side where a user is present.

However, even in the case of using face detection, when the face deviates from an imaging range of the camera so that part of the face is not captured in the captured image, it may not be able to be detected as the face. In this case, there is concern that the operating state is controlled as the absence of a user even though the user is present.

### SUMMARY

One or more embodiments of the present invention provide an information processing apparatus and a control method capable of improving robustness when controlling the operating state using face detection.

An information processing apparatus according to one or more embodiments of the present invention includes: a memory which temporarily stores a program of an OS (Operating System); a first processor which executes the program to implement functions of the OS; and a second processor which detects a face area with a face captured therein from an image captured by an imaging unit, wherein when the face area is no longer detected from a state where the face area is detected by the second processor, the first processor performs first processing to limit use of at least some of the functions of the OS in response to the fact that a state where the face area is not detected has lasted for a predetermined first time, and when there is input by a user before the first time elapses, the first processor disables the first processing, and performs second processing to limit the use of at least some of the functions of the OS in response to the fact that a state where there is no input by the user using the OS functions has lasted for a predetermined second time.

The above information processing apparatus may be such that, when the face area is detected by the second processor before the second time elapses, the first processor enables the first processing, and when the face area is not detected again, the first processor limits the use of at least some of the functions of the OS in response to the fact that the state where the face area is not detected has lasted for the first time.

The above information processing apparatus may also be such that, when the face area is detected by the second processor before the second time elapses, the first processor disables the second processing.

The above information processing apparatus may further be such that the first processor enables the first processing upon performing the second processing, and when the face area is detected by the second processor again, the first processor cancels the limitations of the OS functions limited by the second processing.

Further, the above information processing apparatus may be such that the first time is set shorter than the second time.

A control method according to one or more embodiments of the present invention is a control method for an information processing apparatus including: a memory which temporarily stores a program of an OS (Operating System); a first processor which executes the program to implement functions of the OS; and a second processor which detects a face area with a face captured therein from an image captured by an imaging unit, the control method including: a step in which when the face area is no longer detected from a state where the face area is detected by the second processor, the first processor performs first processing to limit use of at least some of the functions of the OS in response to the fact that a state where the face area is not detected has lasted for a predetermined first time; and a step in which when there is input by a user before the first time elapses, the first processor disables the first processing, and performs second processing to limit the use of at least some of the functions of the OS in response to the fact that a state where there is no input by the user using the OS functions has lasted for a predetermined second time.

The above-described embodiments of the present invention can improve robustness when the information processing apparatus detects the user by face detection to control the operating state.

### BRIEF DESCRIPTION OF THE DRAWINGS

FIGS. 1A-1C are diagrams for describing the outline of HPD processing of an information processing apparatus according to one or more embodiments.

FIG. 2 is a perspective view illustrating an appearance configuration example of the information processing apparatus according to one or more embodiments.

FIG. 3 is a diagram illustrating an example of a person detection range of the information processing apparatus according to one or more embodiments.

FIGS. 4A-4B are diagrams illustrating a detection example of a face area according to one or more embodiments.

FIG. 5 is a diagram illustrating a transition of an operating state when it is determined that a user has left according to one or more embodiments.

FIG. 6 is a diagram illustrating the outline of transitions of the operating state of the information processing apparatus according to one or more embodiments.

FIG. 7 is a schematic block diagram illustrating an example of the hardware configuration of the information processing apparatus according to one or more embodiments.

FIG. 8 is a schematic block diagram illustrating an example of the functional configuration of the information processing apparatus according to one or more embodiments.

FIG. 9 is a flowchart illustrating an example of boot processing according to one or more embodiments.

FIG. 10 is a flowchart illustrating an example of operating state control processing after booting according to one or more embodiments.

### DETAILED DESCRIPTION

Embodiments of the present invention will be described below with reference to the accompanying drawings.

[Outline]

First, the outline of an information processing apparatus 1 according to one or more embodiments will be described. The information processing apparatus 1 according to one or more embodiments is, for example, a laptop PC (Personal Computer). Note that the information processing apparatus 1 may also be any other form of information processing apparatus such as a desktop PC, a tablet terminal, or a smartphone.

The information processing apparatus 1 can make a transition at least between a normal operating state (power-on state) and a standby state as system operating states. The normal operating state is an operating state capable of executing processing without being particularly limited, which corresponds, for example, to S0 state defined in the ACPI (Advanced Configuration and Power Interface) specification. The standby state is a state in which at least some of functions of a system are limited. For example, the standby state may be the standby state or a sleep state, modern standby in Windows (registered trademark), a state corresponding to S3 state (sleep state) defined in the ACPI specification, or the like. Further, a state in which at least the display of a display unit appears to be OFF (screen OFF), or a screen lock state may be included as the standby state. The screen lock is a state in which an image preset to make a content being processed invisible (for example, an image for the screen lock) is displayed on the display unit, that is, an unusable state until the lock is released (for example, until the user is authenticated).

In the following, a transition of the system operating state from the standby state to the normal operating state may also be called “boot.” In the standby state, since the activation level is generally lower than that in the normal operating state, the boot of the system of the information processing apparatus 1 leads to the activation of the operation of the system in the information processing apparatus 1.

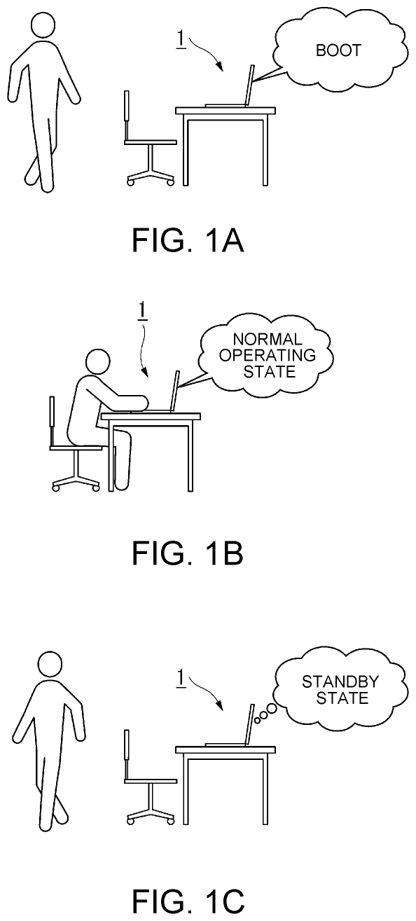

FIGS. 1A-1C are diagrams for describing the outline of HPD processing of the information processing apparatus 1 according to one or more embodiments. The information processing apparatus 1 detects a person (i.e., a user) present in the neighborhood of the information processing apparatus 1. This processing to detect the presence of a person is called HPD (Human Presence Detection) processing. The information processing apparatus 1 detects the presence or absence of a person by the HPD processing to control the operating state of the system of the information processing apparatus 1 based on the detection result. For example, as illustrated in FIG. 1A, when detecting a change from a state where no person is present in front of the information processing apparatus 1 (Absence) to a state where a person is present (Presence), that is, when detecting that a person has approached the information processing apparatus 1 (Approach), the information processing apparatus 1 determines that the user has approached and automatically boots the system to make the transition to the normal operating state. Further, in a state where a person is present in front of the information processing apparatus 1 (Presence) as illustrated in FIG. 1B, the information processing apparatus 1 determines that the user is present and continues the normal operating state. Then, as illustrated in FIG. 1C, when detecting a change from the state where the person is present in front of the information processing apparatus 1 (Presence) to a state where no person is present (Absence), that is, when detecting that the person has left the information processing apparatus 1 (Leave), the information processing apparatus 1 determines that the user has left and causes the system to make the transition to the standby state.

[Appearance Configuration of Information Processing Apparatus]

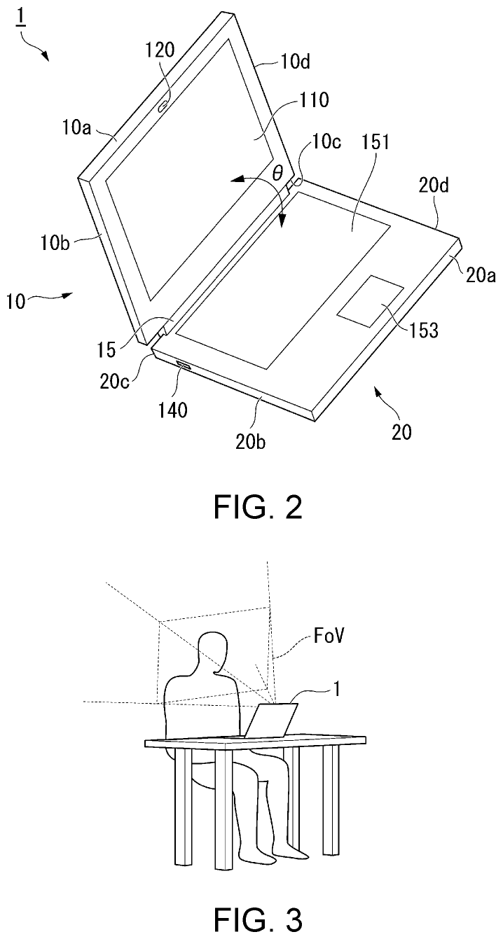

FIG. 2 is a perspective view illustrating an appearance configuration example of the information processing apparatus 1 according to one or more embodiments.

The information processing apparatus 1 includes a first chassis 10, a second chassis 20, and a hinge mechanism 15. The first chassis 10 and the second chassis 20 are coupled by using the hinge mechanism 15. The first chassis 10 is rotatable around an axis of rotation formed by the hinge mechanism 15 relative to the second chassis 20. An open angle by the rotation between the first chassis 10 and the second chassis 20 is denoted by “e” in FIG. 2.

The first chassis 10 is also called A cover or a display chassis. The second chassis 20 is also called C cover or a system chassis. In the following description, side faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c to the side face 20a is referred to as “front.” The right hand and left hand in the rearward direction are referred to as “right” and “left,” respectively. Left side faces of the first chassis 10 and the second chassis 20 are referred to as side faces 10b and 20b, respectively, and right side faces thereof are referred to as side faces 10d and 20d, respectively. Further, a state where the first chassis 10 and the second chassis 20 overlap each other and are completely closed (a state of open angle θ=0°) is referred to as a “closed state.” The faces of the first chassis 10 and the second chassis 20 on the face-to-face sides in the closed state are referred to as respective “inner faces,” and the faces opposite to the inner faces are referred to as “outer faces.” Further, a state opposite to the closed state, where the first chassis 10 and the second chassis 20 are open, is referred to as an “open state.”

The appearance of the information processing apparatus 1 in FIG. 2 illustrates an example of the open state. The open state is a state where the side face 10a of the first chassis 10 and the side face 20a of the second chassis 20 are separated. In the open state, the respective inner faces of the first chassis 10 and the second chassis 20 appear. The open state is one of states when the user uses the information processing apparatus 1, and the information processing apparatus 1 is often used in a state where the open angle is typically about θ=100° to 130°. Note that the range of open angles θ to be the open state can be set arbitrarily according to the range of angles rotatable by the hinge mechanism 15 or the like.

A display unit 110 is provided on the inner face of the first chassis 10. The display unit 110 is configured to include a liquid crystal display (LCD) or an organic EL (Electro Luminescence) display, and the like. Further, an imaging unit 120 is provided in a peripheral area of the display unit 110 on the inner face of the first chassis 10. For example, the imaging unit 120 is arranged on the side of the side face 10a in the peripheral area of the display unit 110. Note that the position at which the imaging unit 120 is arranged is just an example, and it may be elsewhere as long as the imaging unit 120 can face a direction (frontward) to face the inner face of the first chassis 10.

In the open state, the imaging unit 120 captures an image in a predetermined imaging range in the direction (frontward) to face the inner face of the first chassis 10. The predetermined imaging range is a range of angles of view defined by an image sensor included in the imaging unit 120 and an optical lens provided in front of the imaging surface of the image sensor. For example, the imaging unit 120 can capture an image including a person present in front of the information processing apparatus 1.

Further, a power button 140 is provided on the side face 20b of the second chassis 20. The power button 140 is an operating element used by the user to give an instruction to power on or power off, make the transition from the standby state to the normal operating state, make the transition from the normal operating state to the standby state, or the like. Further, a keyboard 151 and a touch pad 153 are provided on the inner face of the second chassis 20 as an input device to accept user's operation input. Note that a touch sensor may also be provided as the input device instead of or in addition to the keyboard 151 and the touch pad 153, or a mouse and an external keyboard may also be connected. When the touch sensor is provided, an area corresponding to the display surface of the display unit 110 may be constructed as a touch panel to accept operations. Further, a microphone used to input voice may be included in the input device.

In the closed state where the first chassis 10 and the second chassis 20 are closed, the display unit 110 and the imaging unit 120 provided on the inner face of the first chassis 10, and the keyboard 151 and the touch pad 153 provided on the inner face of the second chassis 20 are covered with each other's chassis faces, respectively, and put in a state of being disabled from fulfilling the functions.

The information processing apparatus 1 detects the presence of a person within a predetermined range in front of the information processing apparatus 1.

FIG. 3 is a diagram illustrating an example of a person detection range of the information processing apparatus 1 according to one or more embodiments. In the illustrated example, a detection range FoV (Field of View: detection viewing angle) in front of the information processing apparatus 1 is a person-detectable range. For example, the information processing apparatus 1 detects a face area with a face captured therein from a captured image captured forward (on the front side) to determine whether or not a person (user) is present in front of the information processing apparatus 1. The detection range FoV corresponds to an imaging angle of view at which the information processing apparatus 1 captures the image. When the face area is detected from the captured image, the information processing apparatus 1 determines that the user is present. On the other hand, when no face area is detected from the captured image, the information processing apparatus 1 determines that the user is not present.

Here, when the face deviates from the detection range FoV, the face area may not be detected from the captured image even though the user is present in front of the information processing apparatus 1.

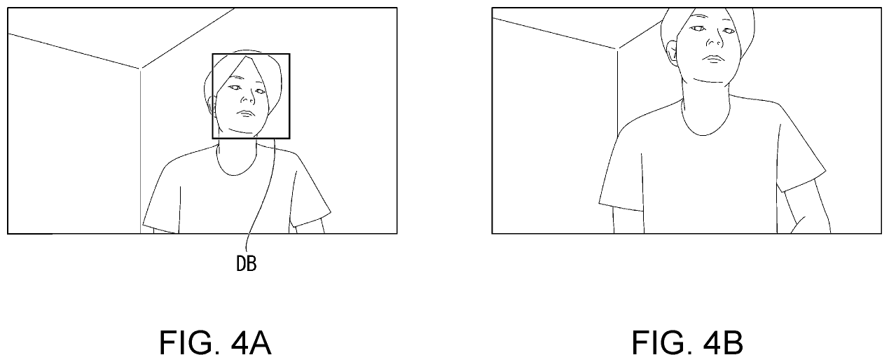

FIGS. 4A-4B are diagrams illustrating a detection example of a face area according to one or more embodiments. FIG. 4A illustrates a state in which the face area of a user is detected from a captured image because the whole face of the user falls within the detection range FoV. A face detection frame DB is displayed corresponding to the face area detected from the captured image. On the other hand, FIG. 4B illustrates a state in which the face area cannot be detected from the captured image because the face of the user deviates from the detection range FoV in such a manner that part of the face of the user is out of the detection range FoV.

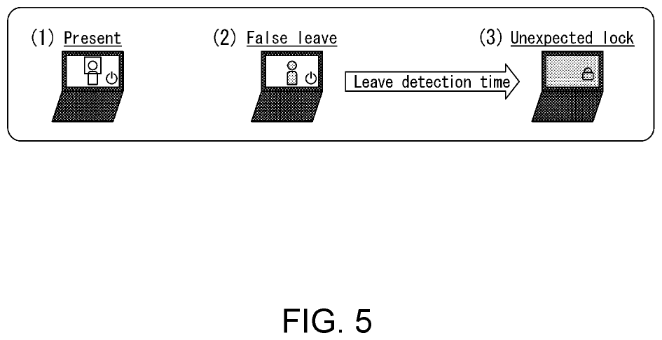

For example, when the posture or pose of the user changes, the face of the user may deviate from the detection range FoV and hence the face area may not be able to be detected from the captured image. Alternatively, when the open angle θ between the first chassis 10 and the second chassis 20 changes, the face of the user may also deviate from the detection range FoV and hence the face area may not be able to be detected from the captured image. Thus, the face area may not be detected from the captured image even though the user is present in front of the information processing apparatus 1. In this case, as illustrated in FIG. 5, it may be falsely determined that the user has left even though the user is present in front of the information processing apparatus 1 and hence the transition to the standby state may be made.

FIG. 5 is a diagram illustrating a transition of the operating state when the leave of the user is determined. (1), (2), and (3) in FIG. 5 illustrate transitions of the operating state of the information processing apparatus 1, respectively.

(1) In the state where the face area is detected from the captured image as illustrated in FIG. 4(A), the information processing apparatus 1 determines that the user is present in front of the information processing apparatus 1, which is in the normal operating state.

(2) When the face area can no longer be detected from the captured image because the face of the user deviates from the detection range FoV as illustrated in FIG. 4(B), the information processing apparatus 1 determines the leave of the user (false determination). For example, when the state where the face area cannot be detected has lasted for a predetermined time after the face area could no longer be detected from the captured image, the information processing apparatus 1 determines that the user has left. The predetermined time until this leave determination is called “leave detection time” below. For example, the leave detection time is set to 30 seconds or the like. Note that the leave detection time may also be able to be set by the user.

(3) When determining that the user has left, the information processing apparatus 1 will make the transition from the normal operating state to the standby state (for example, lock state) by HPD processing even if this determination is false. In other words, even when the user is using the information processing apparatus 1, the information processing apparatus 1 makes the transition to the standby state (for example, lock state), and becomes the standby state (for example, lock state) that is not expected.

Therefore, in one or more embodiments, when there is user input during the leave detection time, the information processing apparatus 1 determines that the determination of the leave of the user because the face area could no longer be detected from the captured image is false, and continues the normal operating state without making the transition to the standby state. Here, the user input is, for example, input on an HID (Human Interface Device) like the input device such as the keyboard 151 or the touch pad 153 (hereinafter called “HID input”).

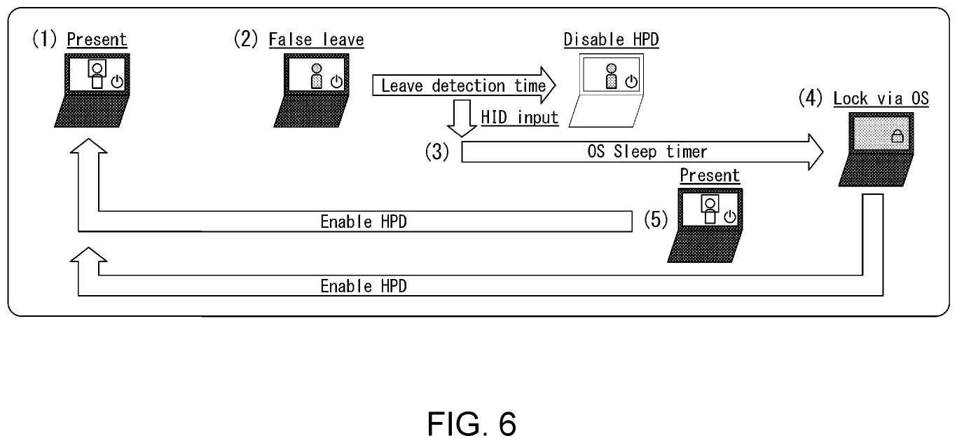

FIG. 6 is a diagram illustrating the outline of transitions of the operating state of the information processing apparatus 1 according to one or more embodiments. (1) to (5) in FIG. 6 illustrate transitions of the operating state of the information processing apparatus 1, respectively.

(1) In the state where the face area is detected from the captured image as illustrated in FIG. 4(A), the information processing apparatus 1 determines the state where the user is present in front of the information processing apparatus 1 (Presence), which is the normal operating state.

(2) When the face area can no longer be detected from the captured image because the face of the user deviates from the detection range FoV as illustrated in FIG. 4(B), the information processing apparatus 1 counts the leave detection time until the determination that the user has left.

(3) When there is HID input before the leave detection time elapses, the information processing apparatus 1 starts counting of a sleep timer by the OS (Operating System) without making the transition to the standby state by HPD processing. The sleep timer is a timer to count the time during which there is no HID input. When a predetermined time counted by the sleep timer has passed, the information processing apparatus 1 makes the transition to the standby state. The predetermined time counted by this sleep timer is the time preset on the OS or set by the user, which is called “sleep setting time” below. For example, the sleep setting time is set to one minute, five minutes, 10 minutes, 30 minutes, or the like. Note that the leave detection time is set shorter than the sleep setting time.

(4) When the state where there is no HID input has lasted for the sleep setting time, the information processing apparatus 1 makes the transition from the normal operating state to the standby state (for example, lock state) by OS processing. In other words, when there is HID input before the leave detection time elapses, the information processing apparatus 1 disables processing to control the operating state by the HPD processing (hereinafter called “HPD control processing”), and enables processing to control the operating state according to the presence or absence of HID input (hereinafter called “HID control processing”). Further, when the transition to the standby state (for example, lock state) is made by the HID control processing, the information processing apparatus 1 turns the HPD control processing back to enabled. Thus, the information processing apparatus 1 performs the HPD control processing to make the transition to the normal operating state when the approach of the user (Approach) is detected, where the state becomes the state where the user is present in front of the information processing apparatus 1 (Presence) illustrated at (1).

(5) Further, when the face area is detected from the captured image before the sleep setting time elapses, since the user is present in front of the information processing apparatus 1 (Presence), the information processing apparatus 1 disables the HID control processing and turns the HPD control processing back to enabled. In other words, the information processing apparatus 1 returns to the state illustrated at (1).

Thus, even in a case where the face area is no longer detected from the captured image in the normal operating state, when it can be determined that the user is using the information processing apparatus 1 based on HID input, the information processing apparatus 1 does not make the transition to the standby state, while when there is no HID input, the information processing apparatus 1 can determine that the user has really left and make the transition to the standby state. Thus, the information processing apparatus 1 can detect the user by face detection and improve robustness when controlling the operating state.

[Hardware Configuration of Information Processing Apparatus]

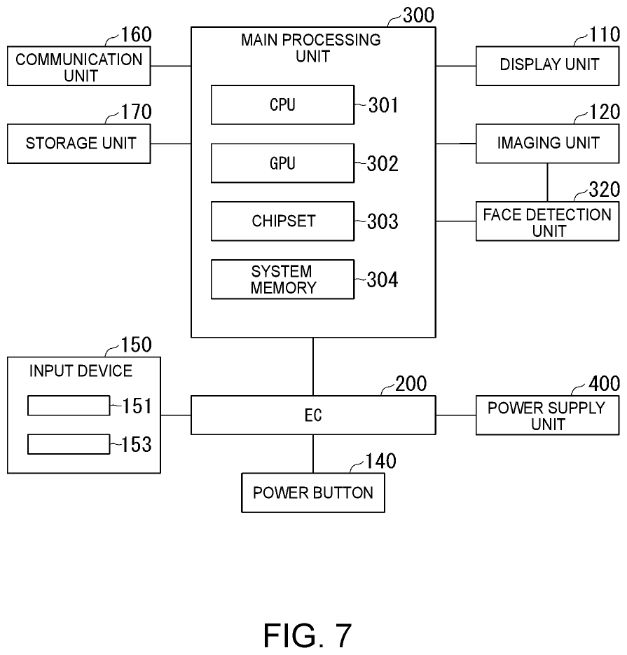

FIG. 7 is a schematic block diagram illustrating an example of the hardware configuration of the information processing apparatus 1 according to one or more embodiments. In FIG. 7, components corresponding to respective units in FIG. 2 are given the same reference numerals. The information processing apparatus 1 is configured to include the display unit 110, the imaging unit 120, the power button 140, an input device 150, a communication unit 160, a storage unit 170, an EC (Embedded Controller) 200, a main processing unit 300, a face detection unit 320, and a power supply unit 400.

The display unit 110 displays display data (images) generated based on system processing executed by the main processing unit 300, processing of an application program running on the system processing, and the like.

The imaging unit 120 captures an image of an object within the predetermined imaging range (angle of view) in the direction (frontward) to face the inner face of the first chassis 10, and outputs the captured image to the main processing unit 300 and the face detection unit 320. For example, the imaging unit 120 is a visible light camera (RGB camera) to capture an image using visible light. Note that the imaging unit 120 may also include an infrared camera (IR camera) to capture an image using infrared light.

The power button 140 outputs, to the EC 200, an operation signal according to a user's operation. The input device 150 is an input unit for accepting user input, which is configured to include, for example, the keyboard 151 and the touch pad 153. In response to accepting operations on the keyboard 151 and the touch pad 153, the input device 150 outputs, to the EC 200, operation signals indicative of operation contents, respectively.

The communication unit 160 is connected to other devices communicably through a wireless or wired communication network to transmit and receive various data. For example, the communication unit 160 is configured to include a wired LAN interface such as Ethernet (registered trademark), a wireless LAN interface such as Wi-Fi (registered trademark), and the like.

The storage unit 170 is configured to include storage media, such as an HDD (Hard Disk Drive) or an SDD (Solid State Drive), a RAM, and a ROM. The storage unit 170 stores the OS, device drivers, various programs such as applications, and various data acquired by the operation of the programs.

The power supply unit 400 supplies power to each unit according to the operating state of each unit of the information processing apparatus 1. The power supply unit 400 includes a DC (Direct Current)/DC converter. The DC/DC converter converts the voltage of DC power, supplied from an AC (Alternate Current)/DC adapter or a battery (battery pack) to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM (Random Access Memory), a ROM (Read Only Memory), an I/O (Input/Output) logic circuit, and the like. The CPU of the EC 200 reads a control program (firmware) prestored in the own ROM, and executes the read control program to fulfill the function. The EC 200 operates independently of the main system processing unit 300 to control the operation of the main processing unit 300 and manage the operating state of the main processing unit 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1. Further, the EC 200 acquires operation signals from the power button 140 and the input device 150, and outputs, to the main processing unit 300, an operation signal related to processing of the main processing unit 300 among the acquired operation signals.

The main processing unit 300 is configured to include a CPU (Central Processing Unit) 301, a GPU (Graphic Processing Unit) 302, a chipset 303, and a system memory 304, where processing of various application programs is executable on the OS (Operating System) by system processing based on the OS.

The CPU 301 executes processing based on a BIOS program, processing based on the OS program, processing based on application programs running on the OS, and the like. The CPU 301 controls the operating state of the system under the control of the chipset 303. For example, the CPU 301 executes boot processing to cause the operating state of the system to make the transition from the standby state to the normal operating state. Further, the CPU 301 executes processing to cause the operating state of the system to make the transition from the normal operating state to the standby state. For example, the CPU 301 executes HID control processing to make the transition from the normal operating state to the standby state (for example, lock state) by OS processing when the state of no HID input has lasted for the sleep setting time.

The GPU 302 is connected to the display unit 110. The GPU 302 executes image processing under the control of the CPU 301 to generate display data. The GPU 302 outputs the generated display data to the display unit 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110, and the EC 200. Further, the chipset 303 has a function as a sensor hub. For example, the chipset 303 acquires the detection result by face detection processing to be acquired from the face detection unit 320, and the like. For example, based on information acquired from the face detection unit 320, the chipset 303 executes HPD processing to detect a person (user), and HPD control processing to control the operating state of the system based on the person detection result.

The system memory 304 is used as a reading area of an execution program of the CPU 301 and a working area to write processed data. Further, the system memory 304 temporarily stores image data of a captured image captured by the imaging unit 120.

Note that the CPU 301, the GPU 302, and the chipset 303 may also be integrated as one processor, or some or all of them may be configured as individual processors. For example, in the normal operating state, the CPU 301, the GPU 302, and the chipset 303 are all operating, but in the standby state, only at least some of the functions of the chipset 303 are operating. In the standby state, at least only functions required for HPD processing upon booting are working.

The face detection unit 320 is configured to include a processor for processing image data of a captured image captured by the imaging unit 120. The face detection unit 320 acquires the image data of the captured image captured by the imaging unit 120, and temporarily stores the acquired image data in a memory. The memory in which the image data is stored may be the system memory 304, or a memory connected to the above processor included in the face detection unit 320.

For example, the face detection unit 320 processes the image data of the captured image acquired from the imaging unit 120 to execute face detection processing for detecting a face area from the captured image, and the like. The face detection unit 320 transmits, to the chipset 303 of the main processing unit 300, the detection result by the face detection processing.

[Functional Configuration of Information Processing Apparatus]

Next, a functional configuration related to HPD control processing and HID control processing in the information processing apparatus 1 will be described in detail.

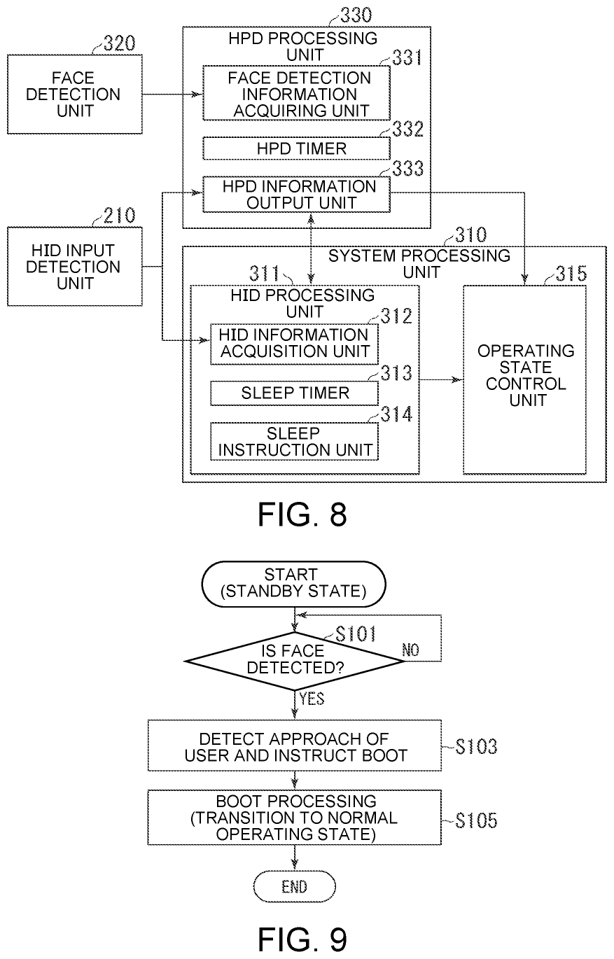

FIG. 8 is a schematic block diagram illustrating an example of the functional configuration of the information processing apparatus 1 according to one or more embodiments. The information processing apparatus 1 includes an HID input detection unit 210, a system processing unit 310, the face detection unit 320, and an HPD processing unit 330.

The HID input detection unit 210 is a functional component included in the EC 200 illustrated in FIG. 7, which detects the presence or absence of HID input based on operation signals from the input device 150 and the like. When there is HID input, the HID input detection unit 210 outputs, to the system processing unit 310 and the HPD processing unit 330, HID input information indicating that there is HID input.

The HPD processing unit 330 is a functional component to execute the HPD processing by processing of the chipset 303. For example, the HPD processing unit 330 includes a face detection information acquiring unit 331, an HPD timer 332, and an HPD information output unit 333 to execute the HPD control processing.

The face detection information acquiring unit 331 acquires, from the face detection unit 320, face detection information indicating whether or not the face area is detected from the captured image. The HPD timer 332 counts, for example, the above-described leave detection time.

Based on the face detection information acquired by the face detection information acquiring unit 331, the HPD information output unit 333 detects the approach of the user to the information processing apparatus 1 (Approach), the presence of the user in front of the information processing apparatus 1 (Presence), or the leave of the user from the information processing apparatus 1 (Leave), and outputs information based on the detection result.

Based on the face detection information acquired by the face detection information acquiring unit 331, the HPD information output unit 333 detects the approach of the user to the information processing apparatus 1 (Approach) when the face area is detected from the state where the face area is not detected from the captured image. For example, when the approach of the user to the information processing apparatus 1 (Approach) is detected in the standby state, the HPD information output unit 333 outputs, to the system processing unit 310, instruction information to instruct the system processing unit 310 to boot the system.

Further, based on the face detection information acquired by the face detection information acquiring unit 331, the HPD information output unit 333 detects the state where the user is present in front of the information processing apparatus 1 (Presence) while the state where the face area is detected from the captured image lasts. For example, the HPD information output unit 333 outputs, to the system processing unit 310, setting information to disable the HID control processing while detecting the state where the user is present in front of the information processing apparatus 1 (Presence) in the normal operating state.

Further, based on the face detection information acquired by the face detection information acquiring unit 331, the HPD information output unit 333 starts counting the leave detection time using the HPD timer 332 when the face area is no longer detected from the state where the face area is detected from the captured image. When the state where the face area is not detected has lasted for the leave detection time, the HPD information output unit 333 detects the leave of the user from the information processing apparatus 1 (Leave). When the leave of the user from the information processing apparatus 1 (Leave) is detected in the normal operating state, the HPD information output unit 333 outputs, to the system processing unit 310, instruction information to cause the system to make the transition to the standby state.

Further, when the HID input information indicating that there was HID input is acquired from the HID input detection unit 210 before the leave detection time elapses after the face area is no longer detected, the HPD information output unit 333 stops counting of the HPD timer 332 and disables the HPD control processing. Then, the HPD information output unit 333 outputs, to the system processing unit 310, setting information to enable the HID control processing.

The system processing unit 310 is a functional component implemented by the CPU 301 executing processing of the BIOS and the OS. For example, the system processing unit 310 includes an HID processing unit 311 and an operating state control unit 315 as functional components by the OS processing.

The HID processing unit 311 includes an HID information acquisition unit 312, a sleep timer 313, and a sleep instruction unit 314 to execute the HID control processing.

The HID information acquisition unit 312 acquires, from the HID input detection unit 210, the HID input information indicating that there was HID input. The sleep timer 313 counts the sleep setting time. The HID information acquisition unit 312 resets the sleep timer 313 each time the HID input information indicating that there was HID input is acquired from the HID input detection unit 210. In other words, the sleep timer 313 counts a duration during which there is no HID input. When the count of the sleep timer 313 reaches the sleep setting time, the sleep instruction unit 314 outputs, to the operating state control unit 315, instruction information to cause the system to make the transition to the standby state.

Note that when acquiring, from the HPD information output unit 333, the setting information to enable the HID control processing, the HID processing unit 311 enables the HID control processing, and when the count of the sleep timer 313 reaches the sleep setting time, the instruction information to cause the system to make the transition to the standby state is output to the operating state control unit 315.

On the other hand, when acquiring the setting information to disable the HID control processing from the HPD information output unit 333, the HID processing unit 311 disables the HID control processing. When disabling the HID control processing, the HID processing unit 311 may perform control to stop counting of the sleep timer 313, or may perform control not to output the instruction information to cause the system to make the transition to the standby state even when the count of the sleep timer 313 reaches the sleep setting time.

The operating state control unit 315 controls the operating state of the system. For example, the operating state control unit 315 controls the operating state of the system to the normal operating state, the standby state, or the like under the control of the HPD processing unit 330. As an example, when acquiring instruction information to give an instruction to boot the system from the HPD processing unit 330, the operating state control unit 315 executes the boot processing to cause the operating state of the system to make the transition from the standby state to the normal operating state. Further, when acquiring, from the HPD processing unit 330, an instruction to cause the operating state of the system to make the transition to the standby state, the operating state control unit 315 causes the operating state of the system to make the transition from the normal operating state to the standby state.

[Operation of Boot Processing]

Referring next to FIG. 9, the operation of the boot processing to cause the information processing apparatus 1 to make the transition from the standby state to the normal operating state by the HPD control processing will be described.

FIG. 9 is a flowchart illustrating an example of boot processing according to one or more embodiments. Here, it is assumed that information processing apparatus 1 is in the standby state, and placed on a desk or the like in the open state.

(Step S101) The HPD processing unit 330 determines whether or not a face area is detected from a captured image based on face detection information acquired from the face detection unit 320. When determining that no face area is detected (NO), the HPD processing unit 330 performs the process in step S101 again. On the other hand, when determining that the face area is detected (YES), the HPD processing unit 330 proceeds to a process in step S103.

(Step S103) In response to the fact that the face area is detected, the HPD processing unit 330 detects the approach of the user to the information processing apparatus 1 (Approach), and outputs, to the system processing unit 310, instruction information to give an instruction to boot the system. Then, the procedure proceeds to a process in step S105.

(Step S105) When acquiring the instruction information to give the instruction to boot the system, the system processing unit 310 executes the boot processing to cause the operating state of the system to make the transition from the standby state to the normal operating state.

[Operation of Operating State Control Processing After Booting]

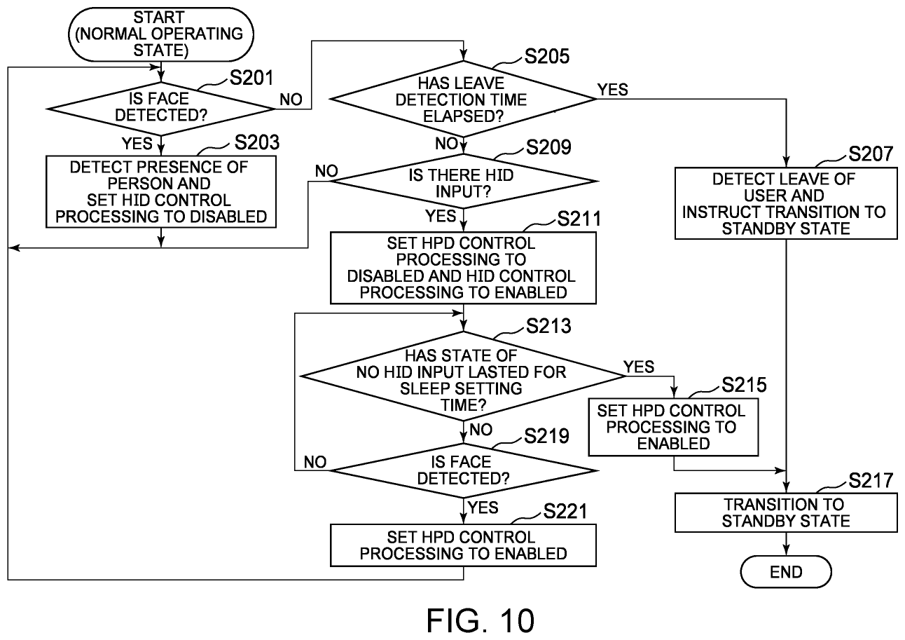

Referring next to FIG. 10, the operation of operating state control processing by the HPD control processing and the HID control processing after booting will be described.

FIG. 10 is a flowchart illustrating an example of operating state control processing after booting according to one or more embodiments.

(Step S201) The HPD processing unit 330 determines whether or not the face area is detected from the captured image based on the face detection information acquired from the face detection unit 320. When determining that the face area is detected (YES), the HPD processing unit 330 proceeds to a process in step S203. On the other hand, when determining that the face area is not detected (NO), the HPD processing unit 330 proceeds to a process in step S205.

(step S203) When determining in step S201 that the face area is detected, the HPD processing unit 330 detects the state where the user is present in front of the information processing apparatus 1 (Presence), and outputs, to the system processing unit 310, setting information to disable the HID control processing. Thus, the system processing unit 310 sets the HID control processing to disabled. Then, the procedure returns to the process in step S201.

(step S205) When determining in step S201 that the face area is not detected, the HPD processing unit 330 determines whether or not the leave detection time has elapsed from the state where the face area was no longer detected. When determining that the leave detection time has elapsed (YES), the HPD processing unit 330 proceeds to a process in step S207. On the other hand, when determining that the leave detection time has not elapsed yet (NO), the HPD processing unit 330 proceeds to a process in step S209.

(Step S207) When determining in step S205 that the leave detection time has elapsed from the state where the face area was no longer detected, the HPD processing unit 330 detects that the user has left from the information processing apparatus 1 (Leave), and outputs, to the system processing unit 310, instruction information to cause the system to make the transition to the standby state. When acquiring, from the HPD processing unit 330, the instruction information to make the transition to the standby state, the system processing unit 310 causes the operating state of the system to make the transition from the normal operating state to the standby state (step S217).

(Step S209) When determining in step S205 that the leave detection time has not elapsed yet, the HPD processing unit 330 determines whether or not HID input information indicating that there was HID input is acquired from the HID input detection unit 210. When determining that the HID input information is not acquired (NO), the HPD processing unit 330 returns to the process in step S201. On the other hand, when determining that the HID input information is acquired (YES), the HPD processing unit 330 proceeds to a process in step S211.

(Step S211) When determining in step S209 that the HID input information is acquired, the HPD processing unit 330 disables the HPD control processing. Further, the HPD processing unit 330 outputs, to the system processing unit 310, setting information to set the HID control processing to enabled. Thus, the system processing unit 310 sets the HID control processing to enabled. Then, the system processing unit 310 proceeds to a process in step S213.

(Step S213) When setting the HID control processing to enabled in step S211, the system processing unit 310 determines whether or not the state where there is no HID input has lasted for the sleep setting time. When determining that the state where there is no HID input has lasted for the sleep setting time (YES), the system processing unit 310 proceeds to a process in step S215. On the other hand, when determining that the state where there is no HID input has not lasted for the sleep setting time (NO), the system processing unit 310 proceeds to a process in step S219.

(Step S215) When determining in step S213 that the state where there is no HID input has lasted for the sleep setting time, the system processing unit 310 outputs, to the HPD processing unit 330, setting information to enable the HPD control processing. Then, the procedure proceeds to a processing in step S217 in which the system processing unit 310 causes the operating state of the system to make the transition from the normal operating state to the standby state.

(Step S219) When determining in step S213 that the state where there is no HID input has not lasted for the sleep setting time, the HPD processing unit 330 determines whether or not the face area is detected from the captured image based on the face detection information acquired from the face detection unit 320. When determining that the face area is not detected (NO), the HPD processing unit 330 returns to the process in step S213. On the other hand, when determining that the face area is detected (YES), the HPD processing unit 330 proceeds to a process in step S221.

(Step S221) When determining in step S219 that the face area is detected, the HPD processing unit 330 sets the HPD control processing to enabled, and returns to the process in step S201.

[Summary]

As described above, the information processing apparatus 1 according to one or more embodiments includes: a memory which temporarily stores an OS program; a first processor which executes the OS program to implement OS functions; and a second processor which detects a face area with a face captured therein from an image captured by an imaging unit. When the face area is no longer detected from a state where the face area is detected by the second processor, the first processor performs first processing to limit use of at least some of the function of the OS (for example, to make the transition to the standby state) according to the fact that the state where the face area is not detected has lasted for the predetermined leave detection time (an example of a first time). Further, when there is input (HID input) by the user before the leave detection time elapses, the first processor disables the first processing and performs second processing to limit use of at least some of functions of the OS in response to the fact that a state where there is no input by the user using the OS functions has lasted for a predetermined sleep setting time (an example of a second time) (for example, to make the transition to the standby state).

Thus, since the information processing apparatus 1 can determine that it is being used by the user when there is HID input even in a case where the face area is no longer detected from the captured image, the transition to the standby state is not made. On the other hand, when there is no HID input, the information processing apparatus 1 can determine that the user has really left and make the transition to the standby state. Therefore, the information processing apparatus 1 can improve robustness when detecting the user by face detection to control the operating state.

Further, when the face area is detected by the second processor before the sleep setting time elapses, the first processor enables the first processing, and when the face area is not detected again, the first processor limits the use of at least some of the functions of the OS in response to the fact that the state where the face area is not detected has lasted for the leave detection time (for example, makes the transition to the standby state).

Thus, since the information processing apparatus 1 does not make the transition to the standby state when the presence of the user can be determined before the sleep setting time elapses even if there is no HID input, the information processing apparatus 1 can control the operating state properly.

For example, the first processor disables the second processing when the face area is detected by the second processor before the sleep setting time elapses.

Thus, since the information processing apparatus 1 does not make the transition to the standby state when the presence of the user can be determined even without HID input while the face area is being detected by the second processor, the information processing apparatus 1 can control the operating state properly.

The first processor enables the first processing when performing the second processing, and when the face area is detected again by the second processor, the first processor unlocks the limitations on the OS functions limited by the HID control processing (for example, makes the transition from the standby state to the normal operating state).

Thus, when making the transition to the standby state after disabling the second processing in response to the fact that the face area is no longer detected by the second processor, the information processing apparatus 1 can be booted by the HPD control processing after that.

For example, the leave detection time is set shorter than the sleep setting time.

Thus, since the probability that the user is not present is higher in the case where no face area is detected by the second processor than in the case of no HID input, the information processing apparatus 1 can make the transition to the standby state as soon as possible to improve security.

Further, a control method for the information processing apparatus 1 according to one or more embodiments includes: a step in which when the face area is no longer detected from a state where the face area is detected by a second processor, a first processor performs first processing to limit use of at least some of functions of the OS in response to the fact that a state where the face area is not detected has lasted for a predetermined leave detection time (the example of the first time) (for example, make the transition to the standby state); and a step in which when there is input (HID input) by a user before the leave detection time elapses, the first processor disables the first processing and performs second processing to limit the use of at least some of the functions of the OS in response to the fact that a state where there is no input by the user using the OS functions has lasted for a predetermined sleep setting time (the example of the second time) (for example, make the transition to the standby state).

Thus, since the information processing apparatus 1 can determine that it is being used by the user when there is HID input even in a case where the face area is no longer detected from the captured image, the transition to the standby state is not made. On the other hand, when there is no HID input, the information processing apparatus 1 can determine that the user has really left and make the transition to the standby state. Therefore, the information processing apparatus 1 can improve robustness when detecting the user by face detection to control the operating state.

While the embodiments of this invention have been described in detail above with reference to the accompanying drawings, the specific configurations are not limited to the above-described embodiments, and design changes are included without departing from the scope of this invention. For example, the respective configurations in the embodiments described above can be combined arbitrarily.

In the aforementioned embodiments, the example in which the HID control processing is set to disabled when the face area is detected in the normal operating state is described, the HID control processing may also be enabled in addition to the HPD control processing even when the face area is detected.

Further, in the aforementioned embodiments, the configuration example in which the imaging unit 120 is built in the information processing apparatus 1 is described, but the present invention is not limited to this example. For example, the imaging unit 120 does not have to be built in the information processing apparatus 1, which may also be attachable to the information processing apparatus 1 (for example, onto any of the side faces 10a, 10b, 10c, and the like) and communicably connected to the information processing apparatus 1 wirelessly or by wire as an external accessory.

Further, in the aforementioned embodiments, the information processing apparatus 1 detects a face area with a face captured therein from a captured image to detect the presence of the user, but the information processing apparatus 1 may also use a distance sensor (for example, a proximity sensor or the like) together to detect the distance to an object in order to detect the presence of the user. For example, the distance sensor is provided on the inner face side of the first chassis 10 to detect an object (for example, a person) present within a detection range in a direction (frontward) to face the inner face of the first chassis 10. As an example, the distance sensor may be an infrared distance sensor configured to include a light-emitting part for emitting infrared light and a light-receiving part for receiving reflected light which is the infrared light returned after emitted and reflected on the surface of the object. Note that the distance sensor may be a sensor using infrared light emitted by a light-emitting diode, or a sensor using an infrared laser emitting a light beam narrower in wavelength band than the infrared light emitted by the light-emitting diode. Further, the distance sensor is not limited to the infrared distance sensor, and it may be a sensor using any other method, such as an ultrasonic sensor or a sensor using a UWB (Ultra Wide Band) radar, as long as the sensor detects the distance to the object. Further, the distance sensor does not have to be built in the information processing apparatus 1, which may also be attachable to the information processing apparatus 1 (for example, onto any of the side faces 10a, 10b, 10c, and the like) and communicably connected to the information processing apparatus 1 wirelessly or by wire as an external accessory. Further, the imaging unit 120 and the distance sensor may be integrally constructed. Further, when the face authentication function is set to be disabled, the information processing apparatus 1 may also detect the presence of the user by detecting an area in which at least part of the body, not just a face, is captured.

Further, in the aforementioned embodiments, the example in which the face area cannot be detected from the captured image because the face of the user deviates from the detection range FoV is described, but the present invention is not limited to this example. For example, when the user wears a mask while using the information processing apparatus 1, the face area may not be able to be detected. Further, when the body including the face within the detection range FoV is targeted for detection, the user may not be able to be detected when the body of the user deviates in addition to the deviation of the face of the user from the detection range FoV.

Further, the CPU 301 (the example of the first processor) and the chipset 303 (the example of the second processor) may be configured as individual processors, or may be integrated as one processor.

Further, in the aforementioned embodiments, the example in which the face detection unit 320 is provided separately from the chipset 303 is illustrated, but some or all of the functions of the face detection unit 320 may be provided in the chipset 303, or provided in a processor integrated with the chipset 303. Further, some or all of the functions of the face detection unit 320 may be provided in the EC 200. Further, in the aforementioned embodiments, the example in which the chipset 303 includes the HPD processing unit 330 is illustrated, but some or all of the functions of the HPD processing unit 330 may be provided in the EC 200.

Further, a hibernation state, a power-off state, and the like may be included as the standby state described above. The hibernation state corresponds, for example, to S4 state defined in the ACPI specification. The power-off state corresponds, for example, to S5 state (shutdown state) defined in the ACPI specification. Note that the standby state, the sleep state, the hibernation state, the power-off state, and the like as the standby state are states lower in power consumption than the normal operating state (states of reducing power consumption).

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. The recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the information processing apparatus 1, or delivery servers for delivering respective divided pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the functions of the information processing apparatus 1 in the above-described embodiments may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, the information processing apparatus 1 in the aforementioned embodiments is not limited to the PC, the tablet terminal, the smartphone, or the like, which may also be a game machine, a multi-media terminal, or the like.

What is claimed is:

1. An information processing apparatus comprising:
a memory which temporarily stores a program of an Operating System (OS);
a first processor which executes the program to implement functions of the OS; and
a second processor which detects a face area with a face captured therein from an image captured by an imaging unit, wherein
when the face area is no longer detected from a state where the face area is detected by the second processor, the first processor performs first processing to limit use of at least some of the functions of the OS in response to the fact that a state where the face area is not detected has lasted for a predetermined first time, and
when there is input by a user before the first time elapses, the first processor disables the first processing, and performs second processing to limit the use of at least some of the functions of the OS in response to the fact that a state where there is no input by the user using the OS functions has lasted for a predetermined second time.

2. The information processing apparatus according to claim 1, wherein when the face area is detected by the second processor before the second time elapses, the first processor enables the first processing, and when the face area is not detected again, the first processor limits the use of at least some of the functions of the OS in response to the fact that the state where the face area is not detected has lasted for the first time.

3. The information processing apparatus according to claim 2, wherein when the face area is detected by the second processor before the second time elapses, the first processor disables the second processing.

4. The information processing apparatus according to claim 1, wherein the first processor enables the first processing upon performing the second processing, and when the face area is detected by the second processor again, the first processor cancels the limitations of the OS functions limited by the second processing.

5. The information processing apparatus according to claim 1, wherein the first time is set shorter than the second time.

6. A control method for an information processing apparatus including: a memory which temporarily stores a program of an Operating System (OS); a first processor which executes the program to implement functions of the OS; and a second processor which detects a face area with a face captured therein from an image captured by an imaging unit, the control method comprising:
a step in which when the face area is no longer detected from a state where the face area is detected by the second processor, the first processor performs first processing to limit use of at least some of the functions of the OS in response to the fact that a state where the face area is not detected has lasted for a predetermined first time; and
a step in which when there is input by a user before the first time elapses, the first processor disables the first processing, and performs second processing to limit the use of at least some of the functions of the OS in response to the fact that a state where there is no input by the user using the OS functions has lasted for a predetermined second time.
